(19) United States
(12) Patent Application Publication
(10) Pub. No.: US 2007/0108901 A1
(43) Pub. Date: May 17, 2007

(54) Electric incandescent lamp and method for fabrication thereof

(75) Inventors: Adrianus Maria Goijaerts, Eindhoven (NL); Wijnand Evert Jacobus Van Kooten, Eindhoven (NL); Bernardus Lambertus Martinus Van Bakel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,420

(22) PCT Filed: Nov. 30, 2004
(86) PCT No.: PCT/IB04/52597

§ 371 Date: Jun. 13, 2006

(30) Foreign Application Priority Data
Dec. 16, 2003 (EP) 03104731.9

(51) Int. Cl. H01K 1/14; H01K 1/50; H01J 9/00

(52) U.S. Cl. 313/578; 313/315; 445/27

(57) ABSTRACT

The present invention provides a method of fabricating an electric incandescent lamp with improved mechanical stability of its filament, the method comprising the steps of: coiling a first coil of a wire having diameter d around a first mandrel having 5 diameter M1 with a first pitch and a first number of turns; winding said first coil around a second mandrel having diameter M2 with a second pitch and a second number of turns to form a coiled coil filament; mounting and arranging the coiled coil filament within a light permeable envelope; hermetically sealing said envelope, heating the coiled coil filament above its recrystallization temperature within the envelope for recrystallization of said coiled coil. The primary and secondary winding preferably have primary and secondary mandrel-to-wire ratios Y1 and Y2, wherein Y1=M1/d>=3 and Y2=M2/(M1+2d)>3. The method according to the present invention enables a further reduction of the length of the coiled coil filament, thus reducing the mechanical stresses caused by gravity in a horizontal burning position and thus improving the structural rigidity of the coiled coil filament.

The present invention relates to a coiled coil filament for an incandescent type electric lamp, such as a high pressure halogen lamp, and to a method for fabrication thereof.

Electric incandescent lamps comprising coiled coil filaments are widely used to decrease the length of the filament. U.S. Pat. No. 4,683,397 provides an electric incandescent lamp comprising: a hermetically sealed light permeable envelope, means for electrically and structurally mounting a filament within the envelope, and a coiled coil filament coupled to and supported by the means for mounting, comprising a filament wire having diameter d, wherein the primary and secondary winding have primary and secondary mandrel-to-wire ratios Y1 and Y2. The known coiled coil filament however can be mechanically unstable, and as a consequence the filament needs additional supporting means, when exceeding certain boundary conditions.

It is an object of the present invention to improve the mechanical stability of the filament.

The present invention therefore provides a method of fabricating an electric incandescent lamp, comprising the steps of:

coiling a first coil of a wire having diameter d around a first mandrel having diameter M1 with a first pitch and a first number of turns;

winding said first coil around a second mandrel having diameter M2 with a second pitch and a second number of turns to form a coiled coil filament;

arranging means for electrically and structurally mounting a filament within a light permeable envelope;

arranging the coiled coil filament within the envelope, coupled to and supported by the means for mounting;

hermetically sealing said envelope,

characterized by heating the coiled coil filament above its recrystallization temperature within the envelope for recrystallization of said coiled coil.

The method according to the present invention enables a further reduction of the length of the coiled coil filament, thus reducing the mechanical stresses caused by gravity in horizontal burning position and thus improving the structural rigidity of the coiled coil filament. Due to the diminished length, the approximation of a point source is improved. This is an advantage when using the lamp in a reflector, as the light can more readily be directed. The produced beam of light is more compact, i.e. the beam comprises more light at equal light yield of the lamp. Clearly, smaller filaments and lamps also contribute towards a reduction of costs.

In a preferred embodiment, the filament wire has diameter d, and the primary and secondary windings have primary and secondary mandrel-to-wire ratios Y1 and Y2, wherein:
Y1=M1/d≧3; and
Y2=M2/(M1+2d)>=3.

The given ratios prove to provide a filament with reduced length. Increasing Y1 and Y2 above the given values further reduces the length of the filament, while preserving the structural rigidity thereof.

In a further preferred embodiment, the method comprises the further steps of:

annealing the first coil at a first annealing temperature after coiling thereof;

cleaning the coiled coil filament in a wet gas;

heat treating the coiled coil filament in a dry gas atmosphere to release stresses therein;

removing the first and the second mandrel by inserting the coiled coil filament in acid.

According to a further aspect, the present invention provides an electric incandescent lamp, comprising:

a hermetically sealed light permeable envelope;

means for electrically and structurally mounting a filament within the envelope; and

a coiled coil filament coupled to and supported by the means for mounting, comprising a filament wire having diameter d, wherein the primary and secondary winding have primary and secondary mandrel-wire ratios Y1 and Y2, wherein:
Y1=M1/d>4; and
Y2=M2/(M1+2d)>4,
wherein M1 is the primary mandrel diameter and M2 is the secondary mandrel diameter.

The filament of the lamp has a reduced length, providing the advantages as described above in relation to the method of fabrication.

In a preferred embodiment, Y1<=8 and/or Y2<=8. These ratios appear to provide a maximum length reduction.

In a further preferred embodiment, Y1>=4.5 and/or Y2>=4.5.

In still a further preferred embodiment, Y1<=6 and Y2<=6.

According to still another aspect, the present invention provides a method for use of a lamp according to any of claims 1-9.

Further advantages and features of the present invention will be elucidated with reference to the annexed figures, in which:

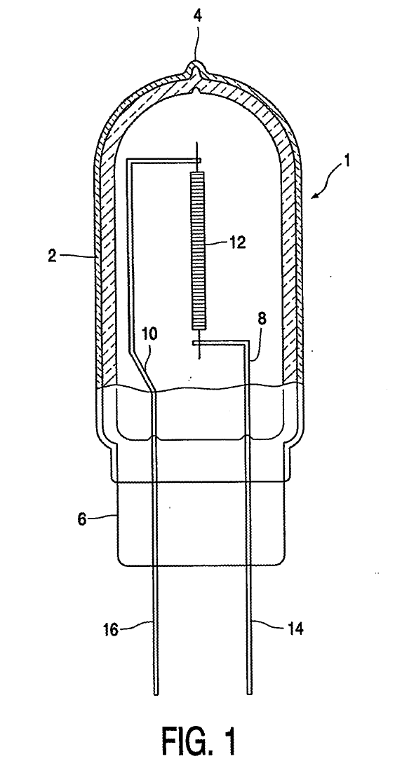

FIG. 1 shows a front elevation of a preferred embodiment of an electric incandescent lamp according to the present invention;

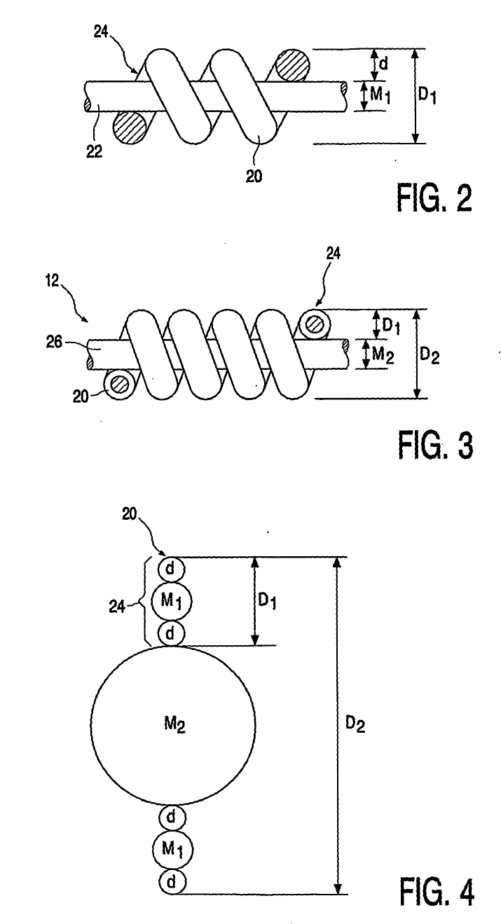

FIG. 2 shows a filament wire wound around a first mandrel to form a first coil;

FIG. 3 shows the first coil of FIG. 2 which is wound around a second mandrel or a needle to form a coiled coil filament; and

FIG. 4 shows the various parameters related to determining the outer diameter of the coiled coil filament of FIG. 3.

An electric incandescent lamp 1 according to the present invention, which is e.g. suited for general lighting purposes and for application in reflectors, comprises a light permeable envelope 2, e.g. a cylindrical bulb of quartz glass (FIG. 1). The inner space of the envelope 2 is filled in a known way with an inert gas mixture, often comprising a halogen additive. One end of the envelope bears a dome with an exhaust tip 4 in the center. The other end of the envelope is hermetically sealed with pinch 6. The substantial parallel outer surfaces of the single pinch 6 are arranged in the center and symmetrically relative to the lamp axis.

Inside the envelope, means are arranged for structurally and electrically mounting a coiled coil filament 12. These means comprise two lead-wires 8, 10 which extend through the pinch 6 to metal contact pins 14, 16 for connecting the lamp to mains voltage, i.e. 220-240 V in Europe and 110-130 V in the US. The filament 12 comprises a coiled coil middle section. Its two ends, which are connected to lead-wires 8, 10, each are singularly coiled. Of course it is equally possible to use the coiled coil filament according to the invention with a double ended lamp, wherein the lead wires are arranged on opposite ends of the envelope.

Referring to FIGS. 2 and 3, the coiled coil filament 12 is fabricated by coiling a wire 20, having diameter d, around a first mandrel 22 having diameter M1. Preferably, the wire 20 is tungsten wire and the first mandrel is of molybdenum. In a preferred embodiment, the first coil 24 is annealed after winding, e.g. at 1550° C. for 10 minutes. Depending on the lamp, these values may vary. The first coil is wound with a first pitch and a first number of turns, and has an outside diameter D1.

To obtain a coiled coil filament 12, the first coil is wound around a second mandrel or needle 26 with a second pitch and a second number of turns, depending on the desired characteristics of the lamp (FIG. 3). The outside diameter is D2.

The coiled coil filament 12 thereafter preferably has two heating treatments. First, a heat treatment in a wet gas, e.g. comprising N₂ and H₂, for cleaning the coils. Second, a heat treatment in a dry gas atmosphere, comprising relatively little or no hydrogen, to release the stresses in the coils. After the heat treatments, the first and possibly the second mandrel can be removed by inserting the coiled coil in an acid, e.g. a mixed acid used for etching.

Until these heat treatments, the (tungsten) wire has not been recrystallized. Firstly, the coiled coil filament is arranged within the envelope 2 in electrical contact with the electrodes 8, 10, after which the envelope is hermetically sealed in a known manner. Subsequently the coiled coil filament is heated above its recrystallization temperature for recrystallizing the wire. Preferably the filament is heated by subjecting it to an electrical current.

Recrystallizing the filament after arrangement thereof in the envelope according to the above mentioned method could reduce the filament length and thus improve the mechanical stability of the coiled coil filament. The method also provides a cost reduction in comparison with recrystallization before arranging the filament within the envelope.

Due to the above mentioned method of fabrication, it is possible to reduce the length of the filament by increasing the mandrel-to-wire ratio (FIG. 4). The first coil has primary mandrel-to-wire ratio Y1 and the second coil has secondary mandrel-to-wire ratio Y2, wherein:
Y1=M1/d; and
Y2=M2/(M1+2d).

By increasing both Y1 and Y2 with a factor of 2, the length of the coiled coil filament can be decreased in the order of a factor of 2, providing an equal light output. For instance, if a known lamp comprises a filament with Y1=2, Y2=2 and length L, the present method can be used to fabricate a filament with Y1=Y2=4 and a length of about 0.5 L. For a further reduction in filament length, Y1 and Y2 can be further increased. Maximum values are for instance Y1<=8 and/or Y2<=8. In practice, Y1<=6 and/or Y2<=6 provide maximum values.

Non limiting examples of practical coil designs of the present invention are given in the table below.

| | 120 V 50 W | 115 V 57 W | 115 V 65 W |
|---|---|---|---|
| Wire diameter (μm) | 42.9 | 47 | 47 |
| Primary pitch (μm) | 69 | 75 | 109 |
| Primary mandrel (μm) | 206 | 230 | 282 |
| Secondary pitch (μm) | 454 | 583 | 750 |
| Secondary mandrel (μm) | 1010 | 1450 | 2260 |
| Number of turns | 11 | 6 | 4 |
| Filament length (mm) | 5 | 3.5 | 3 |
| Y1 = M1/d | 4.8 | 4.89 | 6 |
| Y2 = M2/D1 | 3.5 | 4.48 | 6 |

The protection sought for the present invention is not limited to the above described preferred embodiments thereof, in which many modifications can be envisaged. This protection is defined by the appended claims.

1. Method for fabrication of an electric incandescent lamp, comprising the steps of:
coiling a first coil of a wire having diameter d around a first mandrel having diameter M1 with a first pitch and a first number of turns;
winding said first coil around a second mandrel having diameter M2 with a second pitch and a second number of turns to form a coiled coil filament;
arranging means for electrically and structurally mounting a filament within a light permeable envelope;
arranging the coiled coil filament within the envelope, coupled to and supported by the means for mounting;
hermetically sealing said envelope, characterized by heating the coiled coil filament above its recrystallization temperature within the envelope for recrystallization of said coiled coil.

2. Method according to claim 1, the filament wire having diameter d, wherein the primary and secondary winding have primary and secondary mandrel-to-wire ratios Y1 and Y2, wherein:
Y1=M1/d$>=3; and
Y2=M2/(M1+2d)>=$3.

3. Method according to claim 1, comprising the further steps of:
annealing the first coil at a first annealing temperature after coiling thereof;
cleaning the coiled coil filament in a wet gas;
heat treating the coiled coil filament in a dry gas atmosphere to release stresses therein;
removing the first mandrel by inserting the coiled coil filament in acid.

4. Method according to claim 1, wherein Y1=M1/d>4 and Y2=M2/(M1+2d)>4.

5. Method according to claim 1, wherein Y1<=#8 and/or Y2<=#8.

6. Electric incandescent lamp, comprising:
a hermetically sealed light permeable envelope;
means for electrically and structurally mounting a filament within the envelope; and
a coiled coil filament coupled to and supported by the means for mounting, comprising a filament wire having diameter d, wherein the primary and secondary winding have primary and secondary mandrel-wire ratios Y1 and Y2, wherein:
Y1=M1/d>4; and
Y2=M2/(M1+2d)>4,
wherein M1 is the primary mandrel diameter and M2 is the secondary mandrel diameter.

7. Lamp according to claim 6, wherein Y1#<=8 and/or Y2#<=8.

8. Lamp according to claim 6, wherein Y1>=$4.5 and/or Y2>=$4.5.

9. Lamp according to claim 6, wherein Y1#<=6 and/or Y2#<=6.

10. Lamp according to claim 6, wherein the envelope is filled with a gas comprising halogen.

11. Lamp according to claim 1, wherein the wire is a tungsten wire.
